(19) United States
(12) Patent Application Publication
(10) Pub. No.: US 2017/0074490 A1
(43) Pub. Date: Mar. 16, 2017

(54) DUAL-MODE LIGHTING FIXTURE

(71) Applicant: PHILIPS LIGHTING HOLDING B.V., EINDHOVEN (NL)

(72) Inventor: PATRICK RENE MARIE DESTAIN, ALLEN, TX (US)

(21) Appl. No.: 15/123,305

(22) PCT Filed: Mar. 4, 2015
(86) PCT No.: PCT/IB2015/051569

§ 371 Date: Sep. 2, 2016

Related U.S. Application Data
(60) Provisional application No. 61/947,564, filed on Mar. 4, 2014.

(51) Int. Cl. F21V 14/06; G02B 3/00; F21S 10/00; F21V 5/00; F21V 14/00; G02B 27/09

(52) U.S. Cl. CPC F21V 14/06; F21V 14/00; G02B 27/0961; F21S 10/007; F21V 5/008; G02B 3/005; G02B 3/0062; G02B 27/0966; G02B 27/0916; F21W 2131/406

(57) ABSTRACT

An optical switch (14) is provided that switches between a wash mode and a beam mode. A set of two parallel lenticular lenses (16, 18) with the same focal length are separated by a first distance (24) and are configured to adopt a beam configuration and a wash configuration. In the beam configuration, the parallel lenticular lenses are aligned along an identical axis such that the optical power of the set of lenticular lenses is approximately zero. In the wash configuration, one of the two parallel lenticular lenses is rotated with respect to the other parallel lenticular lenses.

### TECHNICAL FIELD

The present invention is directed generally to a dual-mode automated lighting fixture. More particularly, various inventive methods and apparatus disclosed herein relate to a lighting fixture capable of automated switching between a wash light mode and a beam light mode.

### BACKGROUND

Digital lighting technologies, i.e., illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g., red, green, and blue, as well as a processor for independently controlling the output of the LEDs in order to generate a variety of colors and color-changing lighting effects.

Lighting for architecture or stage entertainment, including concert lighting, theatre lighting, and auditorium lighting, for example, often utilize a large number of lighting fixtures which must each be adjusted or programmed to produce a desired lighting effect. As the demand increases for a greater variety of lighting effects, so does the need for an increased number of lighting fixtures.

Some lighting fixtures, called projection or “beam” lighting fixtures, are designed to emit a narrow-angle output beam to illuminate a target. Typically, the beam of light emitted by the beam lighting fixture is highly controllable. The emitted beam may be, for example, one or many different colors, and can be utilized for long throws or for displaying images or designs. For example, due to the narrow output and control, a beam lighting fixture could be used to display a patterned image with sharp edges. One example of beam lighting fixtures is spotlights.

Other lighting fixtures, called “wash” lighting fixtures, are designed to emit a wide-angle beam that “washes” the stage, surface, or target with light. Typically, the beam of light emitted by the wash lighting fixture is largely uncontrollable. One example of a wash lighting fixtures are floodlights.

Often, a location will have separate beam lighting fixtures and wash lighting fixtures in order to provide both types of lighting effects. Although a single lighting fixture can be configured to operate in a beam mode or a wash mode, switching between the modes requires either user intervention or a significant mechanical switching mechanism that switches one attachment from the front of the light source to another attachment, or places a diffuser in front of the light source. Motorized systems are slow and can take as long as 10 seconds to switch from one mode to another, and must be enclosed to avoid dust and particles from touching any surfaces of the diffuser, motors, and/or other components.

Accordingly, there is a need in the art for methods and apparatus for switching a lighting fixture from one mode to another mode without either user intervention or slow, bulky, and complex mechanical switching mechanisms.

### SUMMARY

The present disclosure is directed to inventive methods and apparatus for switching a lighting fixture from a beam mode to a wash mode, and for switching the lighting fixture from the wash mode to the beam mode. In view of the foregoing, various embodiments and implementations are directed to a lighting fixture with an optical switch attachment in front of the light source which can convert the lighting fixture between operation in a beam mode and operation in a wash mode. The optical switch is composed of a set of two parallel lenticular lens arrays having substantially the same focal length but with opposite signs (i.e., negative and positive focal lengths), and is capable of adopting at least two configurations. In a first configuration of the optical switch, the first and second lenticular lens arrays are aligned along the same axis such that the optical power of the set of lenticular lenses is approximately zero. In this first configuration the lighting fixture operates in beam mode to emit a beam of light that passes through the set of lenticular lenses largely without effect. In a second configuration of the optical switch, either the first or second lenticular lens array is rotated 90 degrees with respect to the other array in the set. In this second configuration the lighting fixture operates in wash mode to emit a beam that is spread by the set of lenticular lenses and washes the target with light.

In some embodiments that provide further lighting effects, the set of two lenticular lens arrays is capable of adopting a third configuration. In this third configuration of the optical switch, either the first or second lenticular lens array is moved away from the other lenticular lens array in the set such that the distance between the two lenticular lens arrays, also called the “air gap,” increases. The distanced lenticular lens arrays act as an anamorphic lens that creates an elliptical effect on light passing through the optical switch. For example, a circular beam or shape will appear as an ellipse, and a square beam or shape will appear as a rectangle. In some embodiments, the distanced lenticular lens arrays can be simultaneously rotated thereby causing the anamorphic beam to rotate at the same angle.

For example, in some embodiments, the lighting fixture is a networked LED-based lighting fixture intended for use in, for example, a home or retail setting. The optical switch can be an attachment that is added to the networked lighting fixture, or can be built into the networked lighting fixture. As one example, the optical switch can be used in conjunction with an existing networked lighting fixture in a home, making the home more like a theatre or a stage setting capable of a wide variety of lighting effects.

Generally, in one aspect, the invention relates to an optical switch configured to switch between a wash mode and a beam mode, with a set of two parallel lenticular lenses having substantially the same focal length, the set of two parallel lenticular lens arrays separated by a first distance and configured to adopt at least a beam configuration and a wash configuration, wherein in the beam configuration, the parallel lenticular lenses are aligned along a substantially identical axis such that the optical power of the set of lenticular lenses is approximately zero, and wherein in the wash configuration, one of the two parallel lenticular lenses is rotated approximately 90 degrees with respect to the other parallel lenticular lenses.

In some embodiments, the optical switch includes a rotation mechanism configured to rotate at least one of the two parallel lenticular lenses. In some embodiments, the optical switch includes a controller configured to direct the rotation mechanism to rotate at least one of the two parallel lenticular lenses.

In some embodiments, the optical switch includes an LED-based light source. In some embodiments, each of two parallel lenticular lenses includes cylindrical lenticules.

In some embodiments, the optical switch includes a GOBO configured to apply a pattern to light emitted from a light source, wherein the GOBO is placed between the light source and the set of two parallel lenticular lenses.

In some embodiments, the set of two parallel lenticular lenses are configured to adopt an anamorphic configuration, wherein in the anamorphic configuration, the first distance is increased.

In some embodiments, the optical switch includes a motor configured to increase and decrease the first distance, and a controller in communication with the motor and programmed or configured to direct the motor to increase or decrease the first distance.

In some embodiments, the optical switch includes a prismatic plate placed between a light source and the set of two parallel lenticular lenses.

Generally, in another aspect, the invention relates to a lighting fixture that includes a light source and an automated optical switch located between the light source and an illumination target, the automated optical switch is to switch between a wash mode and a beam mode, the automated optical switch including a set of two parallel lenticular lenses having substantially the same focal length, the set of two parallel lenticular lenses separated by a first distance and configured to adopt at least a beam configuration and a wash configuration, wherein in the beam configuration, the parallel lenticular lenses are aligned along a substantially identical axis such that the optical power of the set of lenticular lenses is approximately zero, and wherein in the wash configuration, one of the two parallel lenticular lenses is rotated approximately 90 degrees with respect to the other parallel lenticular lens.

In some embodiments, the light source is an LED-based light source.

In some embodiments, the optical switch includes a rotation mechanism configured to rotate at least one of the two parallel lenticular lenses.

In some embodiments, the optical switch includes a controller configured to direct the rotation mechanism to rotate at least one of the two parallel lenticular lenses.

In some embodiments, each of two parallel lenticular lenses includes a plurality of cylindrical lenticules.

In some embodiments, the optical switch includes a GOBO configured to apply a pattern to light emitted from a light source when the GOBO is placed between the light source and the set of two parallel lenticular lenses.

In some embodiments, the set of two parallel lenticular lenses are further configured to adopt an anamorphic configuration, wherein in the anamorphic configuration, the first distance is increased.

In some embodiments, the optical switch includes a motor configured to increase and decrease the first distance, and a controller in communication with the motor and programmed or configured to direct the motor to increase or decrease the first distance.

In some embodiments, the optical switch includes a prismatic plate placed between the light source and the set of two parallel lenticular lenses.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers).

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum. In another implementation, laser-emitted light (such as UV and BLUE) “pumps” the phosphor material.

The term “light source” should be understood to refer to any one or more of a variety of radiation sources, including, but not limited to, LED-based sources (including one or more LEDs as defined above).

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The terms “lighting fixture” or “luminaire” are used interchangeably herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a lighting fixture with an optical switch in accordance with an embodiment of the invention;

FIG. 2A and 2B are schematic representations of optical switches in accordance with an embodiment of the invention;

FIG. 3 is a schematic representation of a lighting fixture with an optical switch in BEAM mode in accordance with an embodiment of the invention;

FIG. 4 is a schematic representation of an optical switch in accordance with an embodiment of the invention;

FIG. 5 is a schematic representation of an optical switch in BEAM mode in accordance with an embodiment of the invention;

FIG. 6 is a schematic representation of an optical switch in WASH mode in accordance with an embodiment of the invention;

FIG. 7 is a schematic representation of an optical switch in WASH mode in accordance with an embodiment of the invention;

FIG. 8 is a schematic representation of a lighting fixture with an optical switch in WASH mode in accordance with an embodiment of the invention;

FIG. 9 is a schematic representation of an optical switch in WASH mode in accordance with an embodiment of the invention;

FIGS. 10A-C are schematic representations of an optical switch in accordance with an embodiment of the invention;

FIG. 11 is a schematic representation of an optical switch in accordance with an embodiment of the invention;

FIGS. 12A-B are schematic representations of a light beam in accordance with an embodiment of the invention;

FIG. 13 is a schematic representation of a prismatic plate in accordance with an embodiment of the invention;

FIGS. 14A-B are schematic representations of a light beam in accordance with an embodiment of the invention; and

FIG. 15 is a schematic representation of an optical switch in accordance with an embodiment of the invention.

### DETAILED DESCRIPTION

It is often desirable to switch a lighting fixture from a beam mode to a wash mode, and vice versa. However, switching between modes requires either user intervention or slow, bulky, and complex mechanical switching mechanisms. Motorized systems, for example, can take as long as 10 seconds to switch from one mode to another and must be enclosed to avoid the unwanted collection of dust and particles.

More generally, Applicants have recognized and appreciated that it would be beneficial to provide a dual-mode automated lighting fixture capable of switching between a wash light mode and a beam light mode. For example, such a lighting fixture would not require direct manipulation by either a user or a complex mechanical switching mechanism.

In view of the foregoing, various embodiments and implementations of the present invention are directed to a lighting fixture with an optical switch attachment in front of the light source which can convert the lighting fixture between operation in a beam mode and operation in a wash mode. The optical switch is composed of a set of two parallel lenticular lens arrays having substantially the same focal length but with opposite signs (i.e., negative and positive focal lengths), and is capable of adopting at least two configurations. In a first configuration of the optical switch, the first and second lenticular lens arrays are aligned along the same axis such that the optical power of the set of lenticular lenses is approximately zero. In this first configuration the lighting fixture operates in beam mode to emit a beam of light that passes through the set of lenticular lenses largely without effect. In a second configuration of the optical switch, either the first or second lenticular lens array is rotated 90 degrees with respect to the other array in the set. In this second configuration the lighting fixture operates in wash mode to emit a beam that is spread by the set of lenticular lenses and washes the target with light.

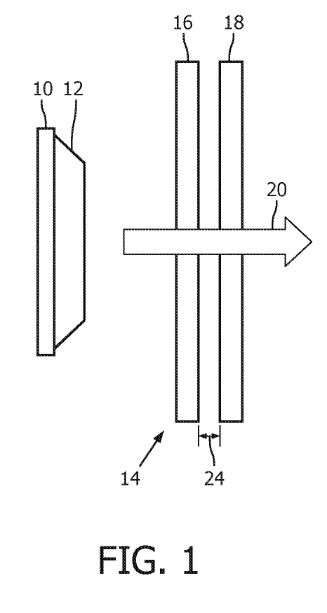

Referring now to the drawings, in FIG. 1 there is shown one embodiment of a lighting fixture 10 including a light source 12. In some embodiments light source 12 includes a plurality of light sources, where one or more of the plurality of light sources is an LED-based light source. The LED-based light source may have one or more LEDs, including an array of LEDs in a linear, two-dimensional, or three-dimensional configuration. The light source can be driven to emit light of a predetermined character (i.e., color intensity, color temperature, etc.). Many different numbers and various types of light sources (all LED-based light sources, LED-based and non-LED-based light sources alone or in combination, etc.) adapted to generate radiation of a variety of different colors may be employed in the lighting fixture. For example, in some embodiments, lighting fixture 10 includes LEDs of two or more different colors. Accordingly, spatial orientation of the light sources may also result in adjustment of the color or color temperature of emitted light.

In the embodiment illustrated in FIG. 1, lighting fixture 10 has a optical switch 14 that is placed between light source 12 and an object or location on which the light beam or beams 20 emitted from light source 12 are targeted. Attachment 14 may be, for example, placed in direct communication with lighting fixture 10, placed in proximity to lighting fixture 10, or may be an integral component of lighting fixture 10. In one embodiment, lighting fixture 10 is a home or office lighting fixture. In yet another embodiment, lighting fixture 10 is a theater, stage, exterior, or other venue lighting fixture.

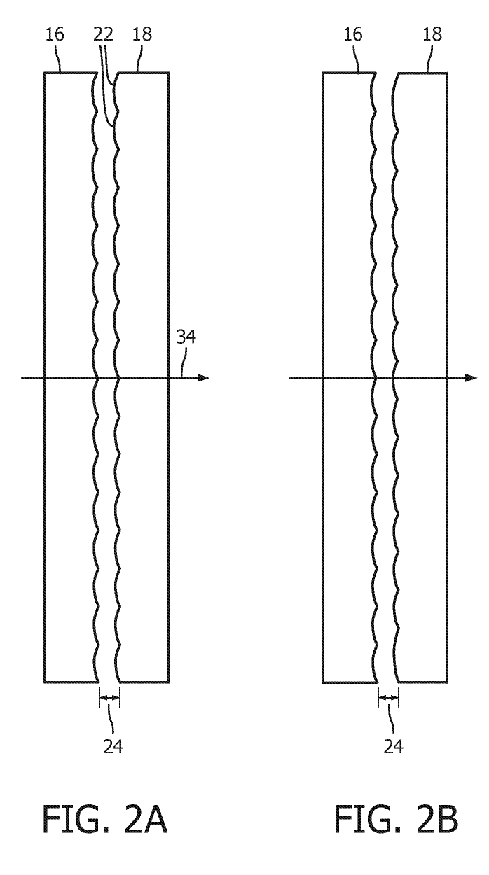

Optical switch 14 includes two lenticular lenses 16 and 18 through which light beam 20 passes. Each of the lenticular lenses may be, for example, an array of cylindrical magnifying lenticules 22 (shown in FIGS. 2A and 2B). The magnifying lenticules 22 may be one or more other shapes in addition to cylindrical, and may all be one shape or can be a variety of different shaps.

The lenticular lenses are substantially optically clear and each of lenticular lenses 16 and 18 has a flat side and a “lenticulated” side comprising a plurality of lenticules 22. The lenticules 22 of lenticular lenses 16 and 18 can be any suitable shape, for example, conical, spherical, triangular, or square, among other shapes, and can be concave or convex. In another plane, such as perpendicular to the above-described concave or convex shape of the lenticules, the lenticules can be any shape, including linear or an arbitrary shape, among others. Lenticular lenses 16 and 18 can be composed of any substantially optically clear material, including glass or any suitable plastic, including for example, one or more of polyester, vinyl, polycarbonate, poly(methyl methacrylate), and polyvinyl chloride, among other materials.

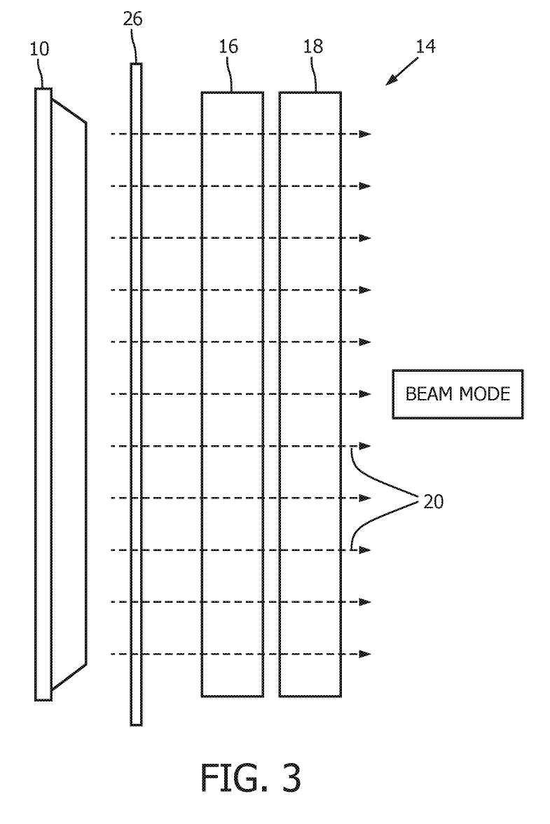

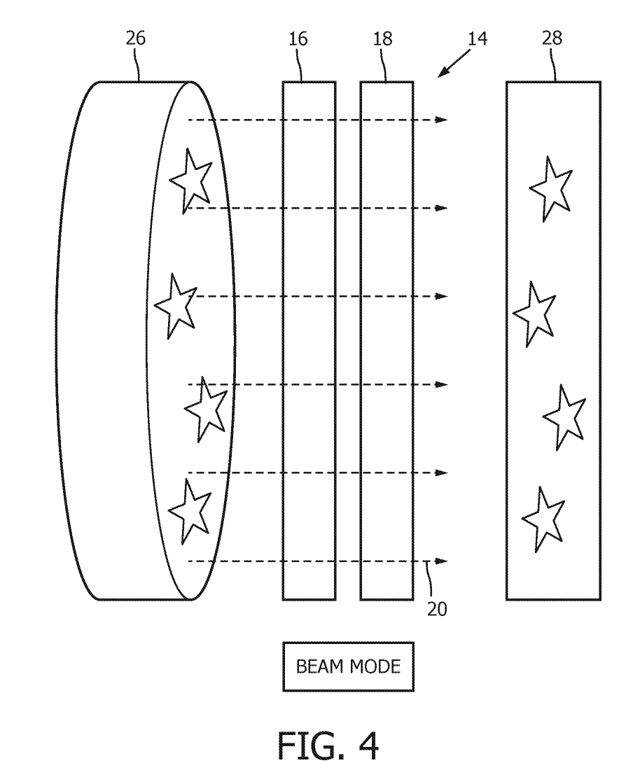

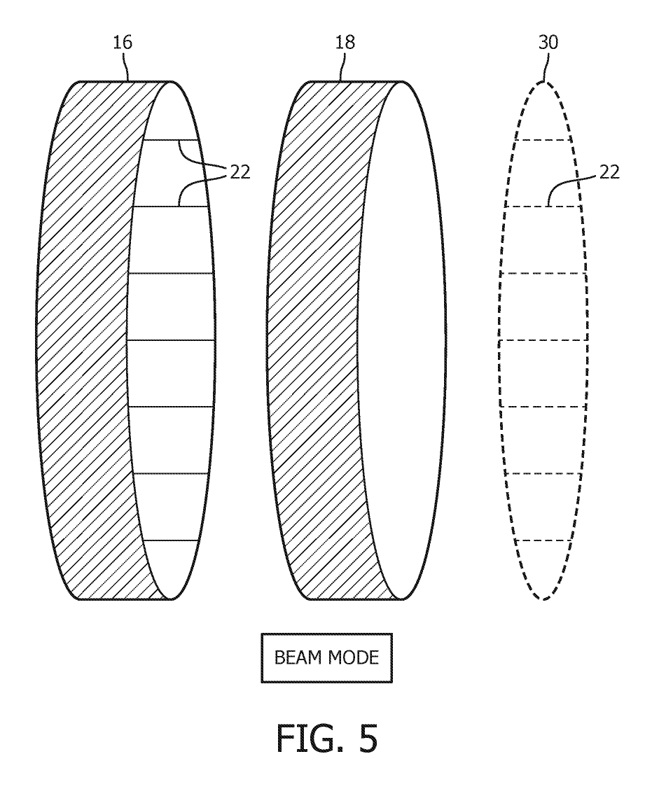

In one embodiment, lenticular lenses 16 and 18 are substantially parallel and are aligned along a substantially identical axis 34, as shown in FIGS. 1 and 2A. In this embodiment, lenticular lenses 16 and 18 have substantially the same focal length but opposite sign such that the focal power of the lenses is approximately zero, and light beam 20 is largely unaffected by the optical switch, as shown in FIGS. 3 and 4. For example, if the focal length of lenticular lens 16 is f1x, and the focal length of lenticular lens 16 is −f1x, then the optical power of optical switch 14 is approximately zero (f1x+(−f1x)=0). In this configuration optical switch 14 is operating in “beam mode.”

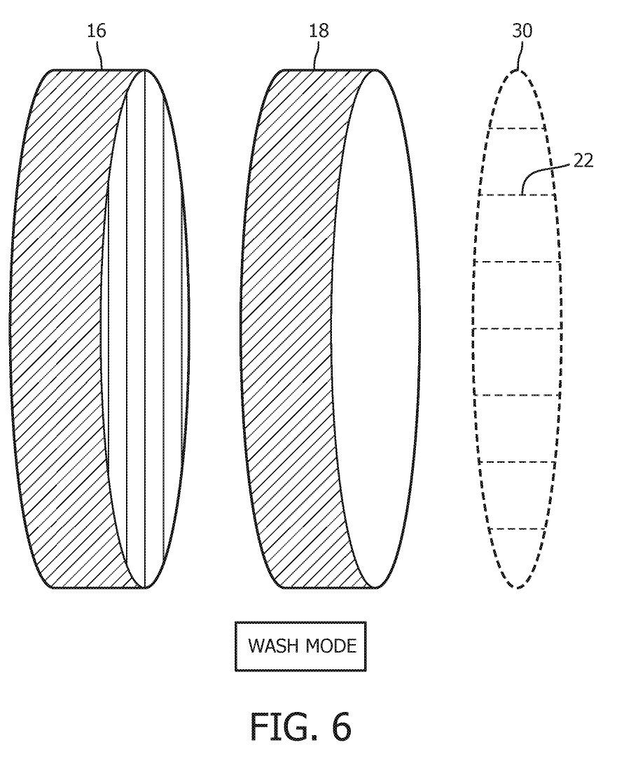

As shown in FIG. 2A, in beam mode when lenticular lenses 16 and 18 are parallel and aligned along a substantially identical axis, the plurality of cylindrical magnifying lenticules 22 (represented by lines) in both lenticular arrays are aligned in a substantially identical direction. In FIG. 5, for example, the plurality of lenticules 22 of lenticular lens 16 are aligned horizontally. The plurality of lenticules 22 of lenticular lens 18 is similarly aligned horizontally, although they are on the reverse face of lenticular lens 18 and therefore not visible. Numeral 30 in FIG. 5 represents the reverse face of lenticular lens 18 with the plurality of lenticules 22 aligned horizontally.

As shown in FIGS. 3 and 4, in beam mode a “Go Between” or “Goes Before Optics” (“GOBO”) template 26 or other component can be placed between the light source 10 and optical switch 14. GOBO 26 manipulates light beam 20 to create a specific pattern of light and shadow on target 28, which may be a screen, person, space, or any other target upon which light beam 20 is emitted. In beam mode, the pattern of light and shadow is discernable despite passing through optical switch 14, as light beam 20 is largely unaffected by lenticular lenses 16 and 18 in beam mode. According to an embodiment, GOBO 26 can be a pixel-based lighting fixture or light valve such as a microelectromechanical systems (MEMS) device, a digital micro-mirror (“DMD”) or a liquid crystal display (“LCD”), among other pixel-based lighting fixture. This pixelation or modification can be automated, or can be based on user input.

Lenticular lenses 16 and 18 are separated by a first distance 24, which may be fixed or adjustable. In one embodiment, first distance 24 is wide enough to avoid mechanical interference of the plurality of lenticules 22 of each of the lenticular lenses 16 and 18 when either lenticular lens 16 or 18 is rotated. For example, as shown in FIGS. 2A and 2B, if either lenticular lens 16 or 18 is rotated around axis 34 (while keeping the lenses substantially parallel), distance 24 is sufficient to prevent any portion of lenticular lenses 16 and 18 from touching or otherwise preventing rotation. However, first distance 24 is narrow enough to prevent significant distortion of light beam 20 when optical switch 14 is in beam mode.

For example, according to one embodiment, the first distance 24 is minimized via utilization of lenticules with a sagitta, or vertex depth, of approximately 0.25 mm, although many other sagitta are possible. The sagitta can be calculated, for example, using the formula h²/2*R where “h” is height and “R” is the radius of curvature. According to this embodiment, a first distance 24 of approximately 1 mm minimizes distortion of light beam 20 when optical switch 14 is in beam mode, although many other distances are possible. According to another embodiment, the width of first distance 24 can be reduced by using lenticular arrays where the sagitta is collapsed to a micrometric level with fine groove pitch.

Optical switch 14 can be placed anywhere along the path of light beams 20 emitted from lighting fixture 10. Placement will affect the ability of the lenticular lenses to adjust the light beams. In one embodiment, for example, optical switch 14 is placed in proximity to light source 12 such that the angle of light beams 20 as they pass through optical switch 14 is minimal, in order to prevent significant distortion of light beam 20 when optical switch 14 is in beam mode. The higher the angle of incidence of light beam 20 as it approaches optical switch 14, the greater the opportunity for distortion as it passes through optical switch 14. For example, optical switch 14 can be placed in front of an optical zoom, if there is one, where the diameter of a lens of lighting fixture 10 will be the greatest.

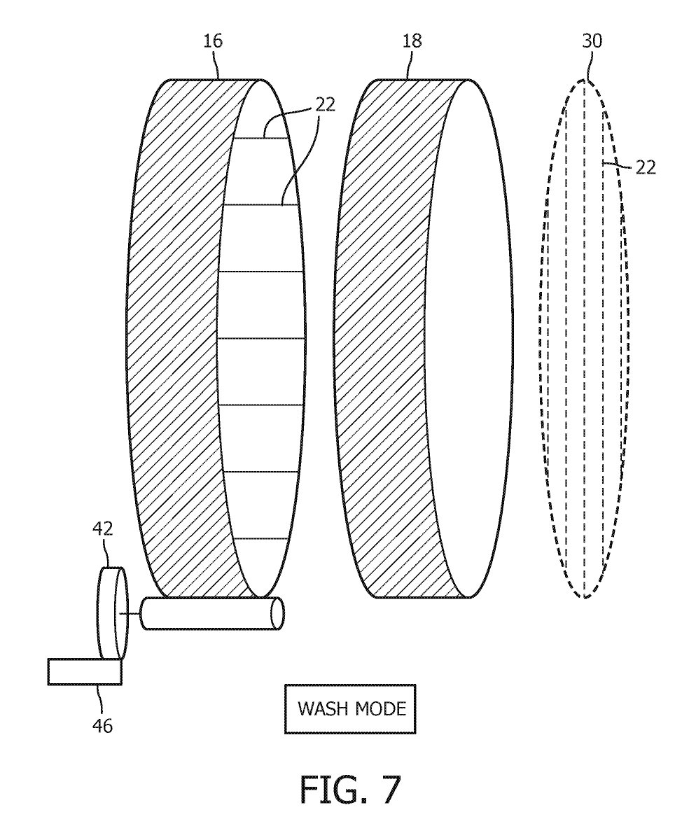

In another embodiment, lenticular lenses 16 and 18 are kept substantially parallel but one of lenticular lens 16 or lenticular lens 18 is rotated approximately 90 degrees with respect to the other lenticular lens. In FIG. 5, for example, optical switch 14 is in beam mode and the plurality of lenticules 22 of lenticular lenses 16 and 18 are aligned horizontally. In FIG. 6, however, lenticular lens 16 only has been rotated approximately 90 degrees to the left of right while keeping the two lenticular lenses substantially parallel. The plurality of lenticules 22 of lenticular lens 16 is now aligned vertically. The plurality of lenticules 22 of lenticular lens 18 are still aligned substantially horizontally, as shown by numeral 30 which represents the reverse face of lenticular lens 18 with the plurality of lenticules 22 aligned horizontally. In this configuration optical switch 14 is operating in “wash mode.”

Optical switch 14 may include a rotation mechanism 42, shown in FIG. 7, configured to rotate one or both of lenticular lenses 16 and 18. For example, the rotation mechanism 42 can rotate only lenticular lens 16, or can rotate only lenticular lens 18. The rotation mechanism 42 can be, for example, a simple motor that turns a track that causes a lens to rotate, or can be in direct communication with one or both of lenticular lenses 16 and 18 to cause rotation. For example, the external surface of one or both of lenticular lenses 16 and 18 and the motor can include meshing teeth that form a simple gear. The rotation may be controlled by a controller 46 in direct or wireless communication with the motor, and rotation can be performed automatically or in response to a stimulus such as a timing element, a user command, or some other internal or external control signal.

In another embodiment shown in FIG. 7, lenticular lens 18 only has been rotated approximately 90 degrees to the left of right while keeping the two lenticular lenses substantially parallel. The plurality of lenticules 22 of lenticular lens 18 are now aligned vertically. The plurality of lenticules 22 of lenticular lens 16 are still aligned substantially horizontally. In this configuration optical switch 14 is again operating in “wash mode.” If either lenticular lens 16 or 18 is rotated 90 degrees from the configuration shown in either FIG. 6 or 7, the optical switch will again be in beam mode.

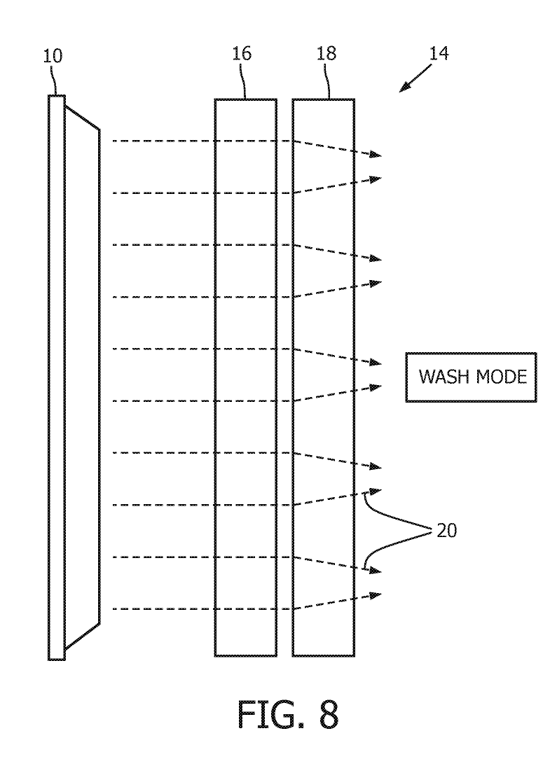

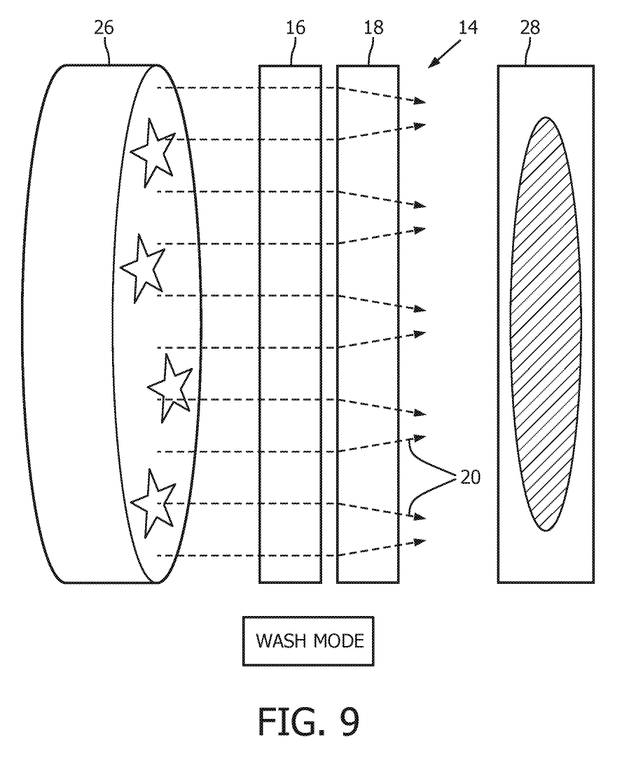

As shown in FIG. 2B, in wash mode when lenticular lenses 16 and 18 are parallel, but the plurality of cylindrical magnifying lenticules 22 (represented by lines) in the two lenticular arrays are no longer aligned in a substantially identical direction. As a result, as shown in FIG. 8, light beams 20 emitted from lighting fixture 10 are no longer unaffected by lenticular lenses 16 and 18, but are now angled. This convolution of light beam 20 will be weak if the optical power of one or more of lenticular lenses 16 and 18 is weak in wash mode.

If GOBO 26 is placed between the light source 10 and optical switch 14, the pattern of light and shadow is distorted or scrambled as light beams 20 are affected by optical switch 14 in wash mode. The resultant light reaching target 28, which may be a screen, person, space, or any other target upon which light beam 20 is emitted, is blurry and thus target 28 is washed with light. According to an embodiment, light beam 20 of optical switch 14 in wash mode can further be blurred or convoluted by defocusing the GOBO. The GOBO can be defocused separately from, or in conjunction with, other actions of the optical switch 14. For example, according to one embodiment, the GOBO is defocused whenever lenticular lenses 16 and 18 are not in alignment, such as when the optical switch is in wash mode. According to another embodiment, the GOBO is separately defocused to provide another layer of functionality separate from the switch between beam mode and wash mode.

In one embodiment, the full divergence angle of light beam 20 traveling through lenticular lenses 16 and 18 of optical switch 14 in beam mode can be, for example, between approximately 8 to 40 degrees. Similarly, the full divergence angle of light beam 20 traveling through lenticular lenses 16 and 18 of optical switch 14 in beam mode can be, for example, between approximately 15 and 50 degrees. Thus, in this embodiment, the increase in the divergence angle of light beam 20 between beam mode and wash mode is approximately 7 to 10 degrees. According to this embodiment, therefore, the optimum focal distance of the lenticular array is approximately 1/(2*sin(10)), or f/2.8. Other focal distances may be optimal if the increase in the divergence angle of light beam 20 between beam mode and wash mode is different, or if other characteristics of light beam 20 are desired.

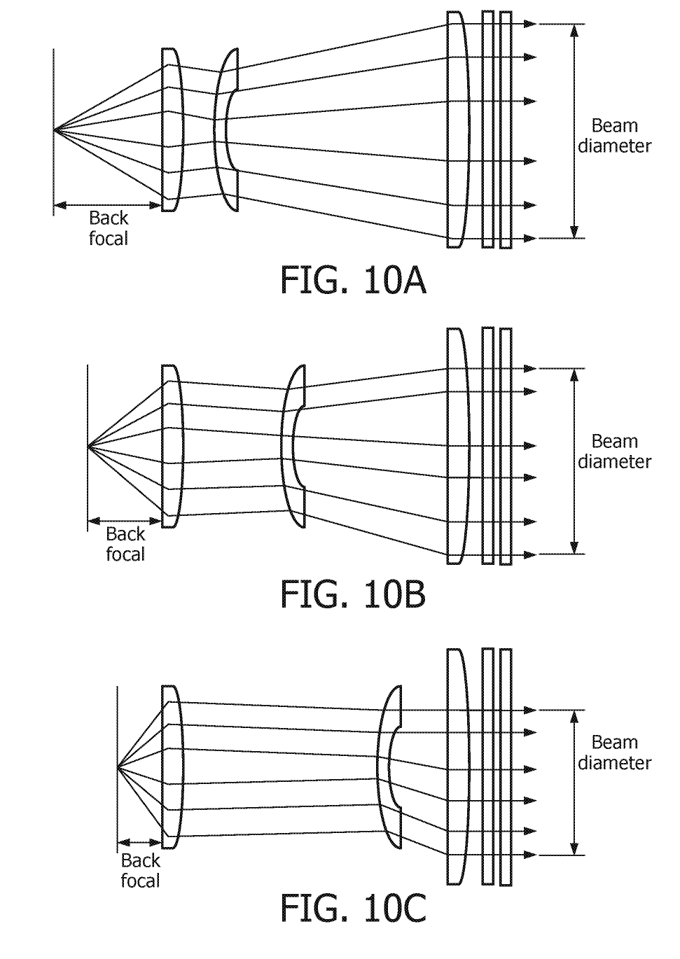

In one embodiment, the optical quality of light beam 20 when optical switch 14 is in beam mode is dependent upon, at least in part, on the full divergence angle of the light beam as well as the intensity of light beam 20. According to an embodiment depicted in FIGS. 10A-C, where FIG. 10A is low zoom, FIG. 10B is medium zoom and FIG. 10C is high zoom, the beam diameter is shown in TABLE 1. In this embodiment, the focal length of the GOBO is approximately f/1.4 to f/1.6, and the diameter of the GOBO is approximately 30 mm.

TABLE 1

| | | | Beam |
|---|---|---|---|
| Zoom | Focal (mm) | Back Focal (mm) | Diameter (degree) |
| Low (FIG. 10A) | 206 | 80 | 8 |
| Medium (FIG. 10B) | 87 | 67 | 20 |
| High (FIG. 10C) | 43 | 58 | 50 |

In another embodiment, one or more of lenticules 22 of lenticular lenses 16 and 18 can be modified to prevent or decrease cross talk or other lighting effects when the distance between the lenticular lenses 16 and 18 increases, or when there is a large angle of incidence. For example, one or more of the lenticules, or a portion of one or more of the lenticules, could be darkened, or the transparency of the lenticule can otherwise be reduced, in order to prevent or decrease cross talk, which can result in a cleaner lighting effect. The lenticule modification can be automatic based on the angle of incidence, detected cross talk or decreased image quality, or based upon some other characteristic of the light or system. According to another embodiment, the lenticule modification can be based upon user input into the system. Further, if a laser light source is utilized, speckle reduction may be employed to improve contrast and/or eliminate cross talk or other lighting effects.

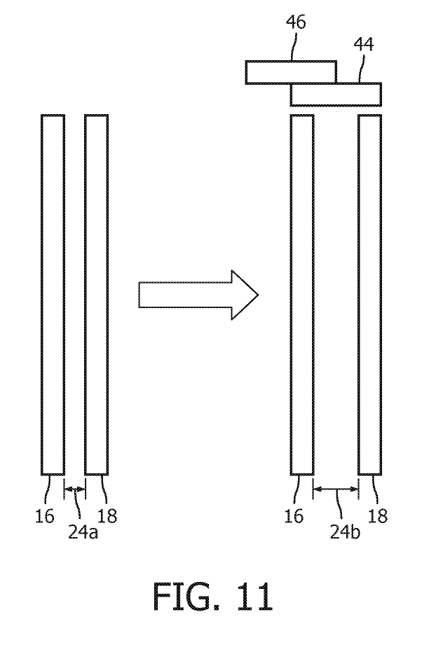

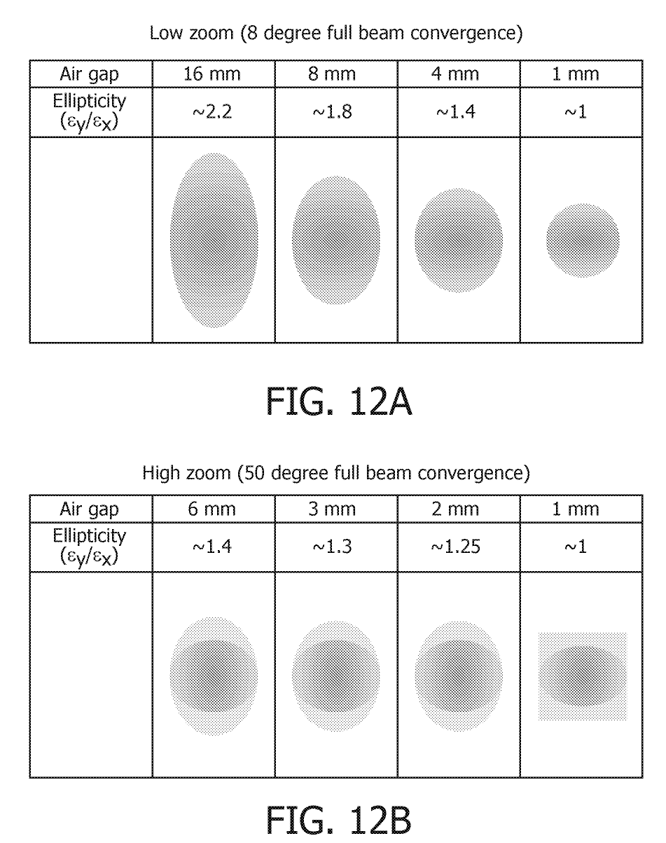

In some embodiments that provide further lighting effects, as depicted in FIGS. 11 and 12A-B, the lenticular lenses 16 and 18 in optical switch 14 are capable of adopting yet another configuration. In this configuration of optical switch 14, either lenticular lens 16 or 18 is moved away from the other lenticular lens in the optical switch such that the distance between the two lenticular lens arrays, first distance 24, increases. For example, as shown in FIG. 11, first distance 24 is increased from a first distance 24a to a second and greater first distance 24b. The optical switch 14 can be designed such that first distance 24 is manually or automatically adjusted. For example, according to one embodiment either lenticular lens 16 or 18 is moved away from the other lens when first distance 24 is increased. Similarly, either lenticular lens 16 or 18 is moved toward the other lens when first distance 24 is decreased. This movement can be automated, or can be performed in response to a user command, a timing element, a sensor, or other control. For example, the movement can be performed by a simple motor 44 that turns a track and causes either lenticular lens 16 or 18 to move in relation to the other lens, both closer together and further apart. As another example, the external surface of one or both of lenticular lenses 16 and 18 and the motor 44 can include meshing teeth that form a simple gear. The motor 44 can be controlled by a controller 46 in direct or wireless communication with the motor, and movement can be performed automatically or in response to a stimulus such as a timing element, a user command, or some other internal or external control signal that communicates with the controller.

As shown in FIGS. 12A-B, the distanced lenticular lenses in optical switch 14 act as an anamorphic lens that creates an elliptical effect on light passing through the optical switch. For example, substantially a circular beam or shape will appear as an ellipse, with the ellipticity depending on several factors including the value of the first distance 24 and the value of the full beam divergence (such as low zoom or high zoom). In other embodiments, a square beam or shape will appear as a rectangle. To provide further functionality to this embodiment of optical switch 14 in which an elliptical effect is created on light passing through the optical switch by increasing the first distance 24 between the lenses, the lenticular lenses 16 and 18 can be rotated simultaneously about the Z-optical axis 34, which results in the beam and the resulting ellipse rotating at approximately the same angle.

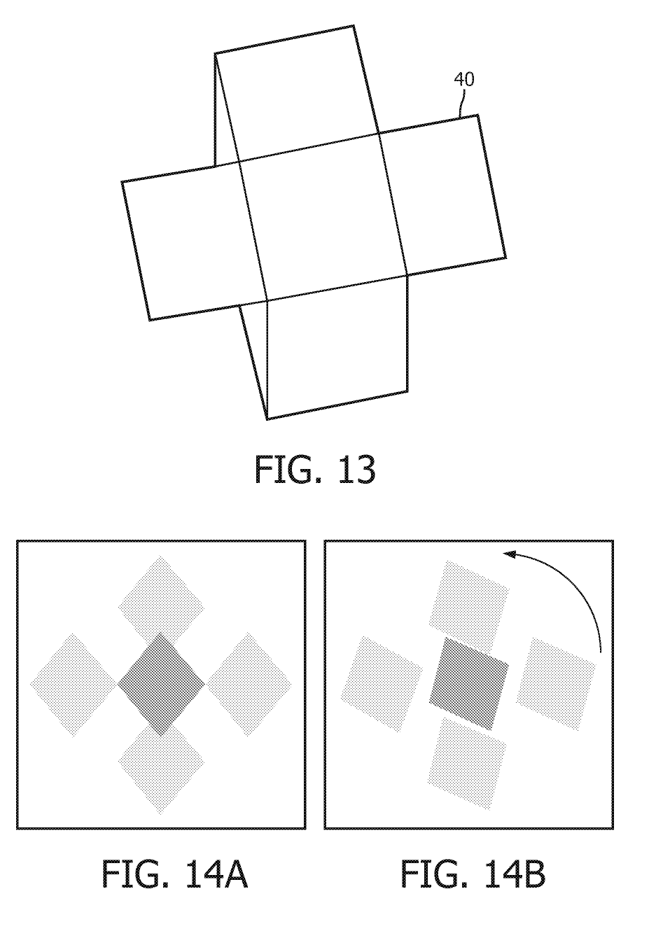

In other embodiments that provide further lighting effects, as depicted in FIGS. 13, 14A, and 14B, the lighting fixture 10 and/or optical switch 14 can be further modified using a prismatic plate 40. For example, in one embodiment, the prismatic plate 40 is placed somewhere between light source 12 and optical switch 14. The prismatic plate 40 causes the generation of multiple GOBO images such as the multiple triangles illustrated in FIG. 14A. When lenticular lenses 16 and 18 can be rotated simultaneously about the Z-optical axis 34, the multiple GOBO images rotate at approximately the same angle. For example, as depicted in FIG. 14B, the triangles have rotated with the rotation of lenticular lenses 16 and 18, with the rotation represented by the arrow. In addition to the prismatic plate 40, any number of other optical elements may be placed between the light source 12 and optical switch 14 in order to create a wide variety of lighting effects.

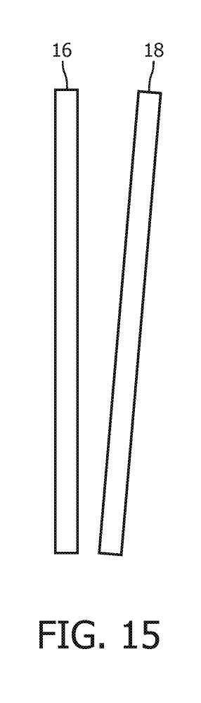

In another embodiment that provides additional lighting effects, as depicted in FIG. 15, the angle of pitch one or both of lenticular lenses 16 and/or 18 can be adjusted such that the two lenses are not parallel. This will result in distortion of light beam 20, and add further functionality to the optical switch.

In one embodiment, the optical switch 14 includes control circuitry with one or more components, including for example a controller 46 which can include a processor and a memory, and a communications module, among other components. In this embodiment, the optical switch 14 is controlled by a single controller, although in other embodiments the lighting fixture can have multiple controllers. The controller 46 is configured or programmed to output one or more signals to optical switch 14, lenticular lenses 16 and 18, and/or other components of the optical switch and/or the lighting fixture 10. For example, controller 46 may be programmed or configured to generate a control signal to rotation mechanism 42 to rotate either lenticular lens 16 or 18 when the optical switch is switching from beam mode to wash mode, or vice versa. Controller 46 may also be configured or programmed to increase and/or decrease the value of first distance 24 by moving one or both of lenticular lenses 16 and 18. This movement can be automated, or can be performed in response to a user command, a timing element, a sensor, or other control, for example. Controller 46 may also be configured or programmed to adjust or monitor lighting fixture 10, including light source 12. Controller 46 may also be configured or programmed to adjust or monitor one or more other optical elements between the light source 12 and optical switch 14. The controller can be, for example, a processor programmed using software to perform various functions discussed herein, and can be utilized in combination with a memory. The memory can store data, including one or more lighting commands or software programs for execution by the processor, as well as various types of data including movement or adjustment of one or both of lenticular lenses 16 and 18, or any other element of the lighting fixture 10 or optical switch 14.

While several inventive embodiments have been described and illustrated herein, those of ordinary skill in the art will readily envision a variety of other systems and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

Reference numerals appearing between parentheses in the claims, if any, are provided merely for convenience and should not be construed as limiting the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An optical switch configured to switch between a wash mode and a beam mode, the optical switch comprising:
a set of two parallel lenticular lenses having substantially the same focal length, the set of two parallel lenticular lens arrays separated by a first distance and configured to adopt at least a beam configuration and a wash configuration; and
a GOBO configured to apply a pattern to light emitted from a light source, wherein the GOBO is positioned between said light source and the set of two parallel lenticular lenses;
wherein in the beam configuration, the parallel lenticular lenses are aligned along a substantially identical axis such that the optical power of the set of lenticular lenses is approximately zero; and
wherein in the wash configuration, one of the two parallel lenticular lenses is rotated with respect to the other parallel lenticular lens.

2. The optical switch of claim 1, wherein in the wash configuration, the degree of rotation of the one of the two parallel lenticular lenses is between 0 and 90 degrees.

3. The optical switch of claim 1, wherein in the wash configuration, the degree of rotation of the one of the two parallel lenticular lenses is approximately 90 degrees.

4. The optical switch of claim 1, further comprising:
a rotation mechanism, wherein the rotation mechanism is configured to rotate at least one of the two parallel lenticular lenses.

5. The optical switch of claim 4, further comprising:
a controller configured to direct the rotation mechanism to rotate at least one of the two parallel lenticular lenses.

6. The optical switch of claim 1, further comprising:
an LED-based light source.

7. The optical switch of claim 1, wherein each of two parallel lenticular lenses comprise cylindrical lenticules.

8. The optical switch of claim 1, wherein the GOBO comprises a microelectromechanical device, a digital micro-mirror, or a liquid crystal display.

9. The optical switch of claim 1, wherein the set of two parallel lenticular lenses are further configured to adopt an anamorphic configuration, wherein in the anamorphic configuration, said first distance is increased.

10. (canceled)

11. The optical switch of claim 1, further comprising a prismatic plate
placed between a light source and the set of two parallel lenticular lenses.

12. A lighting fixture comprising:
a light source;
an automated optical switch located between the light source and an illumination target, wherein the automated optical switch is configured to switch between a wash mode and a beam mode, and further wherein the automated optical switch comprises a set of two parallel lenticular lenses having substantially the same focal length, the set of two parallel lenticular lenses separated by a first distance and configured to adopt at least a beam configuration and a wash configuration;
a rotation mechanism, wherein the rotation mechanism is configured to rotate at least one of the two parallel lenticular lenses;
a controller configured to direct the rotation mechanism to rotate at least one of the two parallel lenticular lenses; and
a GOBO configured to apply a pattern to light emitted from a light source, wherein the GOBO is placed between said light source and the set of two parallel lenticular lenses;
wherein in the beam configuration, the parallel lenticular lenses are aligned along a substantially identical axis such that the optical power of the set of lenticular lenses is approximately zero; and
wherein in the wash configuration, one of the two parallel lenticular lenses is rotated with respect to the other parallel lenticular lens.

13. The lighting fixture of claim 12, wherein in the wash configuration, the degree of rotation of the one of the two parallel lenticular lenses is between 0 and 90 degrees.

14. The lighting fixture of claim 12, wherein in the wash configuration, the degree of rotation of the one of the two parallel lenticular lenses is approximately 90 degrees.

15. The lighting fixture of claim 12, wherein the light source is an LED-based light source.

16. (canceled)

17. The lighting fixture of claim 12, wherein each of two parallel lenticular lenses comprise a plurality of cylindrical lenticules.

18. The lighting fixture of claim 12, wherein the GOBO comprises a microelectromechanical device, a digital micro-mirror, or a liquid crystal display.

19. The lighting fixture of claim 12, wherein the set of two parallel lenticular lenses are further configured to adopt an anamorphic configuration, wherein in the anamorphic configuration, said first distance is increased.

20. The lighting fixture of claim 12,
wherein the rotation mechanism comprises a motor configured to increase and decrease said first distance; and
wherein the controller is in communication with the motor and programmed or configured to direct the motor to increase or decrease said first distance.

21. The lighting fixture of claim 12, further comprising a prismatic plate placed between the light source and the set of two parallel lenticular lenses.

22. An optical switch configured to switch between a wash mode and a beam mode, the optical switch comprising:
a set of two lenticular lenses having substantially the same focal length, the set of two lenticular lens arrays separated by a first distance and configured to adopt at least a beam configuration, a wash configuration, and a distortion configuration;
wherein in the beam configuration, the two lenticular lenses are substantially parallel and are aligned along a substantially identical axis such that the optical power of the set of two lenticular lenses is approximately zero;
wherein in the wash configuration, the two lenticular lenses are substantially parallel, and one of the two parallel lenticular lenses is rotated with respect to the other parallel lenticular lens; and
wherein in the distortion configuration, a pitch of a plane of one of the two lenticular lenses is adjusted such that planes of the two lenticular lenses are not parallel.
